(19) United States
(12) Patent Application Publication
(10) Pub. No.: US 2017/0285254 A1
(43) Pub. Date: Oct. 5, 2017

(54) BACKLIGHT MODULE AND DISPLAY DEVICE

(71) Applicants: Le Holdings (Beijing) Co., Ltd., Beijing (CN); LE SHI ZHI XIN ELECTRONIC TECHNOLOGY (TIAN JIN) LIMITED, Tianjin (CN)

(72) Inventor: Qiaowei Chong, Tianjin (CN)

(73) Assignees: Le Holdings (Beijing) Co., Ltd., Beijing (CN); LE SHI ZHI XIN ELECTRONIC TECHNOLOGY (TIAN JIN) LIMITED, Tianjin (CN)

(21) Appl. No.: 15/240,490

(22) Filed: Aug. 18, 2016

Related U.S. Application Data
(63) Continuation of application No. PCT/CN2016/088994, filed on Jul. 6, 2016.

(30) Foreign Application Priority Data
Mar. 30, 2016 (CN) 201610195396.9
Mar. 30, 2016 (CN) 201620260761.5

(51) Int. Cl. F21V 8/00

(52) U.S. Cl. CPC G02B 6/0088

(57) ABSTRACT

Disclosed are a backlight module and a display device. The backlight module includes a back cover including an accommodation space, a light guiding plate located in the accommodation space, and a lamp bar located between an incident side end face of the light guiding plate, and a blocking wall of the back light, wherein the backlight module further includes: a cam assembly located between a non-incident side end face of the light guiding plate and the blocking wall of the back cover, wherein the cam assembly includes a central shaft fixed to the back cover, a cam body pivoted around the central axis, and a spring pushing the cam body against the non-incident side end face of the light guiding plate.

### CROSS-REFERENCE TO RELATED APPLICATIONS

This application is a continuation of International Application No. PCT/CN2016/088994, filed on Jul. 6, 2016, which is based upon and claims priority to Chinese Patent Application No. 201610195396.9, filed on Mar. 30, 2016, and Chinese Patent Application No. 201620260761.5, filed on Mar. 30, 2016, the entire contents of which are incorporated herein by reference.

### TECHNICAL FIELD

The present disclosure relates to the field of display technologies, and particularly to a backlight module and a display device.

### BACKGROUND

At present, Light Emitting Diodes (LEDs) are commonly used as light sources in a backlight module of a liquid crystal display device, and the backlight module can be categorized into a direct-type backlight module, and an edge-lighting type backlight module, dependent upon the positions where the light sources are distributed.

As illustrated in FIG. 1, a general structure of the edge-lighting type backlight module in the liquid crystal display device includes a back cover 11 including an accommodation space, a reflector 12, a light guiding plate 13, and an optical sheet 14 which are located and arranged sequentially in the accommodation space, a LED BAR 15 located at the light incidence side of the light guiding plate 13, and a mold frame 16 located above the optical sheet 14 and connected with the back cover 11.

A drawback in the prior art lies in that since the light guiding plate expands upon being heated, and contracts upon being cooled, a sufficient gap for expansion needs to be reserved between the light guiding plate and the LED BAR, and between the light guiding plate and the back cover in order to avoid the deformation of the expanding and contracting light guiding plate from influencing an optical characteristic of the backlight module. However the inventors of the disclosure have identified that the light guiding plate may frequently be scratched while vibrating during a reliability test on the existing backlight module, thus degrading the product eligibility ratio of the backlight module.

### SUMMARY

Embodiments of the disclosure provide a backlight module and a display device so as to reduce the vibrating scratch applied on the light guiding plate to thereby improving the product eligibility ratio of the backlight module.

Some embodiments of the disclosure provide a backlight module including a back cover having an accommodation space, a light guiding plate located in the accommodation space, and a lamp bar located between an incident side end face of the light guiding plate, and a blocking wall of the back cover, wherein the backlight module further includes:
a cam assembly located between non-incident side end face of the light guiding plate, and the blocking wall of the back cover, wherein the cam assembly includes a central shaft fixed to the back cover, a cam body pivoted around the central axis, and a spring pushing the cam body against the other side end face than the light incident side end face of the light guiding plate.

Optionally the cam body is a circular cam body installed eccentrically relative to the central shaft.

Optionally the cam body is a triangular cam body, a square cam body, or an irregular cam body.

Optionally the spring is a columnar helix spring with one end being fixed to the central shaft, and the other end being fixed to the cam body.

Optionally the spring is a planar spiral spring with one end being fixed to the central shaft, and the other end being fixed to the cam body.

Optionally there are at least two groups of cam assemblies between the non-incident side end face of the light guiding plate, and the blocking wall of the back cover.

Optionally the cam assembly is arranged between each non-incident side end face of the light guiding plate, and the blocking wall of the back cover.

In the technical solutions according to the embodiments of the disclosure, if the light guiding plate expands, then the cam assembly will free a part of the space, and energy will be accumulated in the spring to thereby avoiding the light guiding plate from being deformed while expanding and being extruded; and if the light guiding plate contracts, then the energy in the spring will be discharged so that the cam body is pushed against the non-incident side end face of the light guiding plate. As compared with the prior art, the inventive solution can have the light guiding plate fixed tightly while the light guiding plate is expanding upon being heated, and contracting upon being cooled, to thereby alleviating vibrating from the light guiding plate from in the backlight module so as to reduce the vibrating scratch of the light guiding plate, thus improving the product eligibility ratio of the backlight module.

Some embodiments of the disclosure further provide a display device including the backlight module according to any one of the technical solutions above. Since the vibrating scratch of the light guiding plate in the backlight module of the display device is alleviated, the display device can be provided with a better product quality.

### BRIEF DESCRIPTION OF THE DRAWINGS

In order to make the technical solutions according to the embodiments of the disclosure or in the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a schematic structural diagram of a cross section of the backlight module in the prior art;

FIG. 2 is a schematic top view of a backlight module according to some embodiments of the disclosure;

FIG. 3 is a schematic top view of a backlight module according to another embodiment of the disclosure;

FIG. 4 is a schematic diagram of a cam assembly according to some embodiments of the disclosure;

FIG. 5 is a schematic diagram of a cam assembly according to another embodiment of the disclosure; and

FIG. 6 is a schematic diagram of an expanding light guiding plate cooperating with the cam assembly.

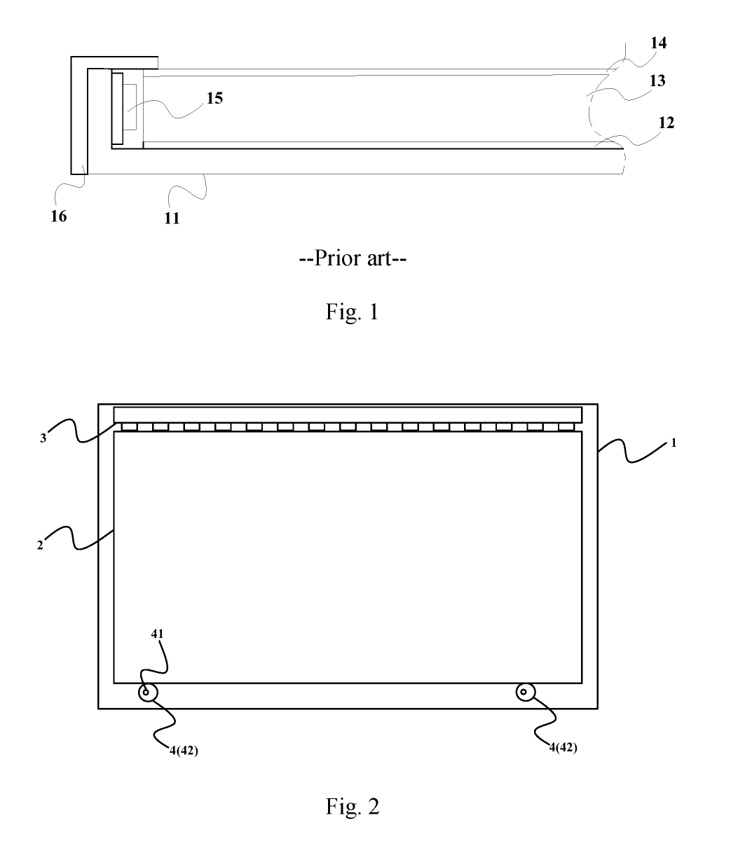

### REFERENCE NUMERALS

In the prior art:
11—Back cover;
12—Reflector;
13—Light guiding plate;
14—Optical sheet;
15—LED BAR;
16—Mold frame

In the embodiments of the disclosure:
1—Back cover
2—Light guiding plate;
3—Lamp BAR;
4—Cam assembly;
41—Central shaft;
42—Cam body;
43—Spring.

### DETAILED DESCRIPTION OF THE EMBODIMENTS

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

As illustrated in FIG. 2, a backlight module according to some embodiments of the disclosure includes a back cover 1 including an accommodation space, a light guiding plate 2 located in the accommodation space, and a lamp bar 3 located between an incident side end face of the light guiding plate 2, and a blocking wall of the back light 1, where the backlight module further includes:

A cam assembly 4 located between a non-incident side end face of the light guiding plate 2, and the blocking wall of the back cover 1, where the cam assembly 4 includes a central shaft 41 fixed to the back light 1, a cam body 42 pivoted around the central axis 41, and a spring 43 pushing the cam body 42 against the non-incident side end face of the light guiding plate 2.

In addition to the structural members above, the structural of the backlight module generally further includes a reflector, an optical sheet, a mold frame, etc., none of which is illustrated.

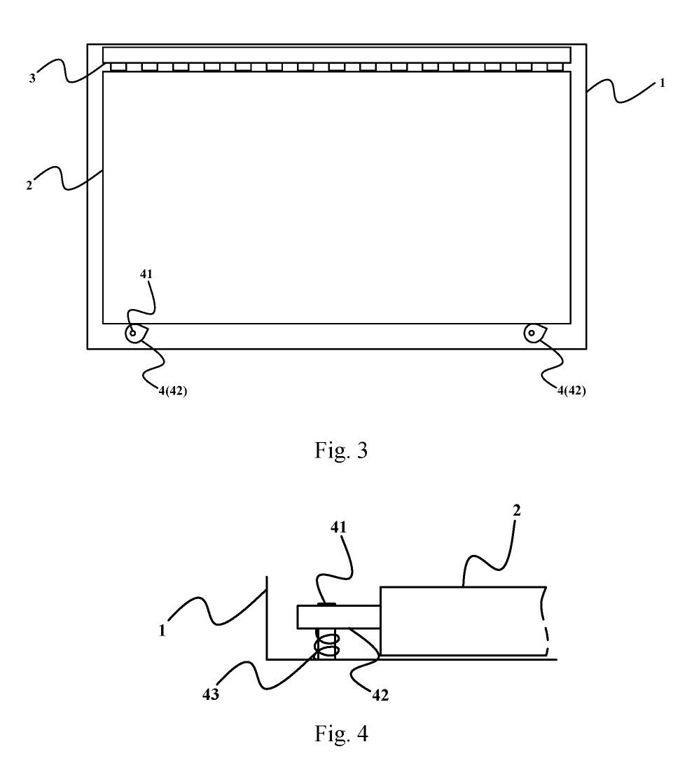

The cam assembly 4 will not be limited to any particular structural form, for example, as illustrated in FIG. 2, the cam body 42 of the cam assembly is a circular cam body installed eccentrically relative to the central shaft 41, that is, the cam body 42 is an eccentric cam. Alternatively the cam body can be a triangular cam body, a square cam body, an irregular cam body, etc., and can be installed eccentrically or concentrically relative to the central shaft 41. As illustrated in FIG. 3, the cam body 42 is shaped like a water drop.

As illustrated in FIG. 4, in some embodiments of the disclosure, the spring 43 is a columnar helix spring with one end being fixed to the central shaft 41, and the other end being fixed to the cam body 42.

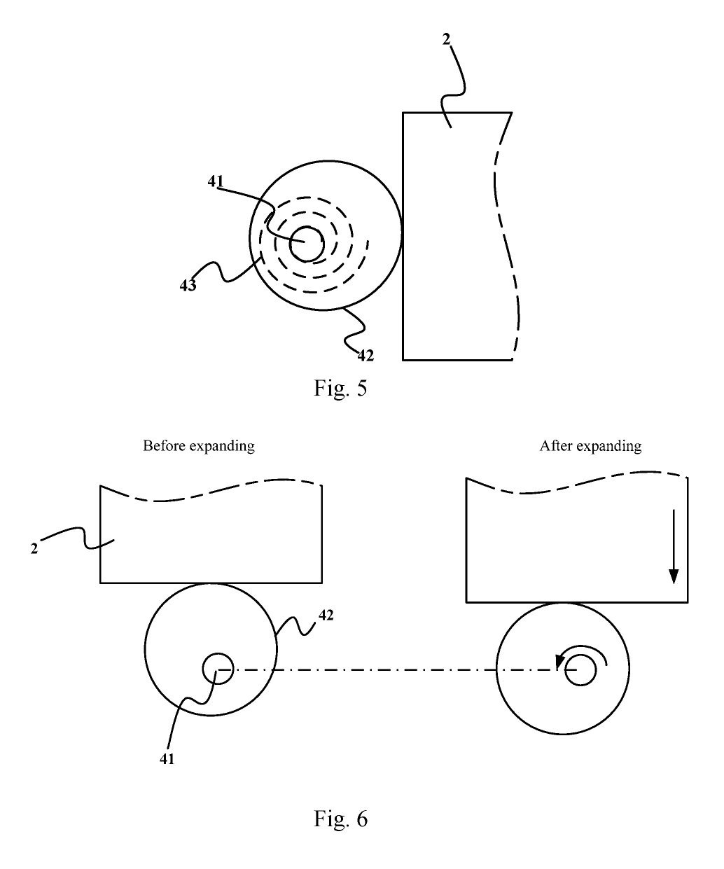

As illustrated in FIG. 5, in some embodiments of the disclosure, the spring 43 is a planar spiral spring with one end being fixed to the central shaft 41, and the other end being fixed to the cam body 42.

As illustrated in FIG. 6, if the light guiding plate 2 expands in the arrowed direction as illustrated, then an acting force will be applied to the cam body 42 so that the cam body 42 is rotated counterclockwise by some angle, and energy is accumulated in the spring to thereby freeing a part of the space so as to avoid the light guiding plate 2 from being deformed while expanding and being extruded.

On the contrary, if the light guiding plate contracts, then the energy in the spring will be discharged so that the cam body is rotated clockwise by some angle while a restoring force of the spring is applied thereto, and thus pushed against the non-incident side end face of the light guiding plate.

As compared with the prior art, the inventive solution can have the light guiding plate fixed tightly while the light guiding plate is expanding upon being heated, and contracting upon being cooled, to thereby reducing vibration from the light guiding plate from in the backlight module so as to reduce the vibrating scratch of the light guiding plate, thus improving the product eligibility ratio of the backlight module.

As illustrated in FIG. 2, in a preferred embodiment o the disclosure, there are at least two groups of cam assemblies 4 between the non-incident side end face of the light guiding plate 2, and the blocking wall of the back cover 1 so that the light guiding plate 2 can be provided with more balanceable holding forces so as to fix the light guiding plate 2 more firmly in the backlight module.

Preferably the cam assembly is arranged between each non-incident side end face of the light guiding plate, and the blocking wall of the back cover so that holding forces can be applied to the upper, lower, left, and right end faces of the light guiding plate to thereby fixing the light guiding plate more firmly in the backlight module. If the light guiding plate expands in any direction, then the cam assembly will free a part of the space to thereby avoiding the light guiding plate from being deformed while expanding and being extruded.

Some embodiments of the disclosure further provide a display device including the backlight module according to any one of the technical solutions above. Since the vibrating scratch of the light guiding plate in the backlight module of the display device is alleviated, the display device can be provided with a higher product quality. The display device will not be limited to any particular type, for example, the display device can be a liquid crystal TV set, a liquid crystal display, a tablet PC, a mobile phone, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1-8. (canceled)

9. A backlight module, comprising a back cover comprising an accommodation space, a light guiding plate located in the accommodation space, and a lamp bar located between an incident side end face of the light guiding plate, and a blocking wall of the back light, wherein the backlight module further comprises:
a cam assembly located between a non-incident side end face of the light guiding plate, and the blocking wall of the back cover, wherein the cam assembly comprises a central shaft fixed to the back cover, a cam body pivoted around the central axis, and a spring pushing the cam body against the non-incident side end face of the light guiding plate.

10. The backlight module according to claim 9, wherein the cam body is a circular cam body installed eccentrically relative to the central shaft.

11. The backlight module according to claim 9, wherein the cam body is a triangular cam body, a square cam body, or an irregular cam body.

12. The backlight module according to claim 9, wherein the spring is a columnar helix spring with one end being fixed to the central shaft, and the other end being fixed to the cam body.

13. The backlight module according to claim 9, wherein the spring is a planar spiral spring with one end being fixed to the central shaft, and the other end being fixed to the cam body.

14. The backlight module according to claims 9, wherein there are at least two groups of the cam assemblies between the non-incident side end face of the light guiding plate, and the blocking wall of the back cover.

15. The backlight module according to claims 9, wherein the cam assembly is arranged between each the non-incident side end face of the light guiding plate, and the blocking wall of the back cover.

16. A display device, comprising a backlight module comprising an accommodation space, a light guiding plate located in the accommodation space, and a lamp bar located between an incident side end face of the light guiding plate, and a blocking wall of the back light, wherein the backlight module further comprises:
a cam assembly located between a non-incident side end face of the light guiding plate, and the blocking wall of the back cover, wherein the cam assembly comprises a central shaft fixed to the back cover, a cam body pivoted around the central axis, and a spring pushing the cam body against the non-incident side end face of the light guiding plate.

17. The display device according to claim 16, wherein the cam body is a circular cam body installed eccentrically relative to the central shaft.

18. The display device according to claim 16, wherein the cam body is a triangular cam body, a square cam body, or an irregular cam body.

19. The display device according to claim 16, wherein the spring is a columnar helix spring with one end being fixed to the central shaft, and the other end being fixed to the cam body.

20. The display device according to claim 16, wherein the spring is a planar spiral spring with one end being fixed to the central shaft, and the other end being fixed to the cam body.

21. The display device according to claim 16, wherein there are at least two groups of the cam assemblies between the non-incident side end face of the light guiding plate, and the blocking wall of the back cover.

22. The display device according to claim 16, wherein the cam assembly is arranged between each the non-incident side end face of the light guiding plate, and the blocking wall of the back cover.
